(19) United States
(12) Patent Application Publication
(10) Pub. No.: US 2024/0419140 A1
(43) Pub. Date: Dec. 19, 2024

(54) RECORDING MEDIUM, IMAGE GENERATION DEVICE, AND PROGRAMMABLE CONTROLLER SYSTEM

(71) Applicant: Mitsubishi Electric Corporation, Tokyo (JP)

(72) Inventors: Keisuke NAKAJIMA, Tokyo (JP); Terumasa YASUI, Tokyo (JP)

(73) Assignee: Mitsubishi Electric Corporation, Tokyo (JP)

(21) Appl. No.: 18/714,573

(22) PCT Filed: Feb. 15, 2022
(86) PCT No.: PCT/JP2022/005999

§ 371 Date: May 30, 2024

(51) Int. Cl. G05B 19/042; G06F 3/147; G06T 11/00

(52) U.S. Cl. CPC G05B 19/042; G06F 3/147; G06T 11/00; G05B 2219/24102

(57) ABSTRACT

A program causes an image generation device to function as an acquirer and a generator. The acquirer acquires FB information indicating a function block corresponding to a routine contained in an operation program for operating a PLC. The acquirer acquires individual configuration information determined individually for the function block. The individual configuration information defines a configuration of a status image representing statuses of parameters related to the function block that result from performance of the function of the function block. The generator generates, based on the individual configuration information, a status image representing a result of the performance of the function of the function block, and outputs the generated status image to a UI.

### TECHNICAL FIELD

The present disclosure relates to an image generation program, an image generation device, a programmable controller system, and an image generation method.

### BACKGROUND ART

In the fields of factory automation (FA), such as factories, a programmable controller is operated in accordance with preliminarily generated operation programs to control a large number of machines. Some of the operation programs are efficiently written using function blocks corresponding to so-called routines. The function blocks can be distributed to many users and allow the users to utilize the functions of the function blocks without coding tasks. For example, the users in the fields are supplied with function blocks concerning the machines to be controlled, from the manufacturer of the machines.

In order to generate such an operation program in the fields, desired is a technique for allowing the users to observe statuses of parameters related to a function block that result from trial performance of the function of the function block. Conceivable examples of the technique include application of a partial simulation on the function block corresponding to a part of the program (for example, refer to Patent Literature 1).

### CITATION LIST

### Patent Literature

Patent Literature 1: Unexamined Japanese Patent Application Publication No. 2021-082034

### SUMMARY OF INVENTION

### Technical Problem

The technique disclosed in Patent Literature 1, however, does not involve a configuration of a screen to be presented to a user for observation of the process or result of the partial simulation. The user who observes the functions of function blocks is thus provided with a user interface preliminarily implemented in a device that executes the partial simulation. A maker can design and implement a user interface pursuant to the specification common to various function blocks to achieve high efficiency, but will suffer from low user-friendliness. In contrast, the maker can specifically design and implement user interfaces pursuant to various specifications for different function blocks to improve the user-friendliness, but will suffer from a large number of tasks. The user interface for observation of the functions of function blocks is required to achieve both high user-friendliness and low burden on the maker who designs and implements the user interface.

An objective of the present disclosure, which has been accomplished in view of the above situations, is to achieve, for a user interface for observation of the functions of function blocks, both high user-friendliness and low burden on the user who designs and implements the user interface.

### Solution to Problem

In order to achieve the above objective, an image generation program according to the present disclosure causes a computer to function as: acquisition means for acquiring function block information indicating function blocks corresponding to routines contained in an operation program for operating a programmable controller, and acquiring individual configuration information determined individually for the function blocks, which defines a configuration of a status image representing statuses of parameters related to each of the function blocks and resulting from performance of a function of the function block; and generation means for generating, based on the individual configuration information, the status image representing a result of the performance of the function of the function block, and outputting the generated status image to a display device.

### Advantageous Effects of Invention

According to the present disclosure, the acquisition means acquires individual configuration information on individual function blocks that defines a configuration of a status image, and the generation means generates a status image on the basis of the individual configuration information. The maker who desires a user-friendly user interface is thus only required to prepare the individual configuration information, without designing or implementing user interfaces for the individual function blocks from scratch. The resulting user interface for observation of the functions of function blocks can therefore achieve both high user-friendliness and low burden on the maker who designs and implements the user interface.

### BRIEF DESCRIPTION OF DRAWINGS

FIG. 1 illustrates a functional configuration of an image generation device according to Embodiment 1;

FIG. 2 illustrates a hardware configuration of the image generation device according to Embodiment 1;

FIG. 3 illustrates an example of a function block according to Embodiment 1;

FIG. 4 illustrates a status image generated on the basis of individual configuration information according to Embodiment 1;

FIG. 5 illustrates an example of the individual configuration information according to Embodiment 1;

FIG. 6 illustrates an example of common configuration information according to Embodiment 1; FIG. 7 illustrates a status image generated on the basis of the common configuration information according to Embodiment 1;

FIG. 8 is a flowchart illustrating a process of generating an image according to Embodiment 1;

FIG. 9 illustrates a status image generated on the basis of the individual configuration information and the common configuration information according to Embodiment 1;

FIG. 10 illustrates an example of individual configuration information according to Embodiment 2; and

FIG. 11 illustrates individual configuration information and multiple pieces of common configuration information having priorities according to Embodiment 3.

### DESCRIPTION OF EMBODIMENTS

An image generation device 10 according to embodiments of the present disclosure is described in detail below with reference to the accompanying drawings.

### Embodiment 1

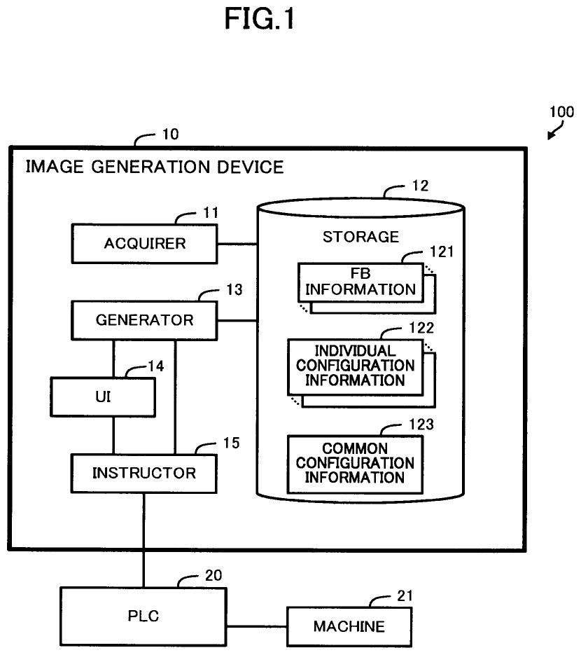

As illustrated in FIG. 1, the image generation device 10 according to this embodiment and a programmable logic controller (PLC) 20 for controlling machines 21 constitute a programmable controller system 100. The programmable controller system 100 is a factory automation (FA) system for managing the contents of operations of the PLC 20.

The PLC 20 is a control apparatus corresponding to an example of a programmable controller. The PLC 20 controls one or more machines 21 in accordance with operation programs provided from the image generation device 10, and thus achieves various processes, such as production lines. The operation programs each correspond to an example of a program for operating a programmable controller. For example, the PLC 20 controls a machine 21 having a robot arm on the basis of results of sensing by another machine 21 serving as a sensor in accordance with a ladder program, which is a kind of the operation programs. The PLC 20 thus controls the flow of works on a belt conveyor. Although FIG. 1 illustrates the PLC 20 as a representative, multiple PLCs 20 may cooperate with each other to control one or more machines 21.

The PLC 20 is connected to the machines 21 via signal lines for transmitting voltage signals or current signals, communication lines for transmitting serial data, or an industrial network. The PLC 20 is connected to the image generation device 10 via a communication line, such as a universal serial bus (USB) cable, or a local area network (LAN).

The image generation device 10 is a computer, such as an industrial personal computer (PC), and corresponds to a terminal for managing the PLC 20. The image generation device 10 executes software called an engineering tool, and thus edits the content of an operation program to be executed by the PLC 20, writes the generated operation program into the PLC 20, and reads the data stored in a memory of the PLC 20. The image generation device 10 also generates a status image representing a status of a function block resulting from actual performance of the function block and a test run of the PLC 20, and presents a test run screen containing the status image to the user. The function block corresponds to a routine contained in the operation program.

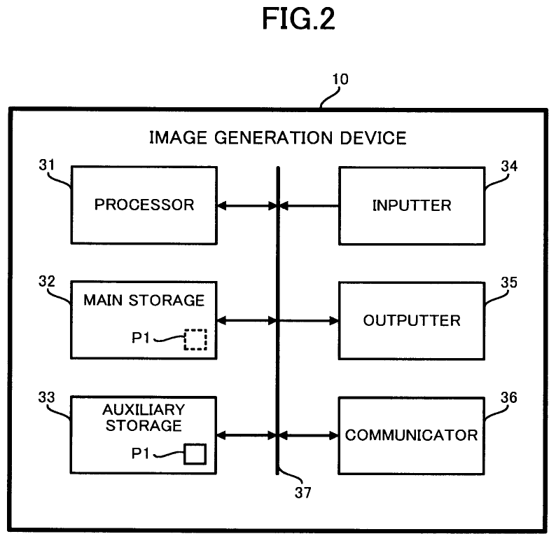

FIG. 2 illustrates a hardware configuration of the image generation device 10. The image generation device 10 includes a processor 31, a main storage 32, an auxiliary storage 33, an inputter 34, an outputter 35, and a communicator 36, as illustrated in FIG. 2. The main storage 32, the auxiliary storage 33, the inputter 34, the outputter 35, and the communicator 36 are each connected to the processor 31 via internal buses 37.

The processor 31 includes a central processing unit (CPU) or a micro processing unit (MPU). The processor 31 executes a program P1 stored in the auxiliary storage 33 and thus performs various functions described below. The program P1 corresponds to an example of an image generation program for causing the image generation device 10 to perform various functions.

The main storage 32 includes a random access memory (RAM). The main storage 32 receives the program P1 loaded from the auxiliary storage 33. The main storage 32 serves as a work area of the processor 31.

The auxiliary storage 33 includes a non-volatile memory, such as an electrically erasable programmable read-only memory (EEPROM). The auxiliary storage 33 stores the program P1 and various types of data to be used in processes in the processor 31. The auxiliary storage 33 provides the processor 31 with data to be used by the processor 31, and stores data fed from the processor 31, under the instructions from the processor 31.

The inputter 34 includes an input device, such as a keyboard. The inputter 34 acquires information input by the user of the image generation device 10 and outputs the acquired information to the processor 31.

The outputter 35 includes an output device, such as a liquid crystal display (LCD). The outputter 35 presents various types of information to the user under the instructions from the processor 31.

The communicator 36 includes a communication interface circuit to communicate with external apparatuses. The communicator 36 receives signals from an external apparatus and outputs information indicated by the signals to the processor 31. The communicator 36 also transmits signals indicating the information output from the processor 31 to an external apparatus.

The above-described hardware components cooperate with each other and thus allow the image generation device 10 to perform functions for generating a status image, which presents a status of the function block under execution to the user. In detail, as illustrated in FIG. 1, the image generation device 10 has functional components including an acquirer 11 to acquire FB information 121, individual configuration information 122, and common configuration information 123 and cause the information to be stored into the storage 12, the storage 12 to store the information provided from the acquirer 11, a generator 13 to generate a status image of a function block using the information stored in the storage 12, a user interface (UI) 14 to present a test run screen containing the status image to the user, and an instructor 15 to transmit an instruction to execute a test run to the PLC 20 in accordance with an operation input by the user through the UI 14.

The acquirer 11 is mainly achieved by cooperation of the processor 31 and the inputter 34. The acquirer 11 acquires the FB information 121, the individual configuration information 122, and the common configuration information 123, which are input by the user.

The FB information 121 corresponds to an example of function block information indicating function blocks. The function blocks are each a reusable program component corresponding to a so-called routine, that is, a collection of multiple instructions. The function block can retain variables therein. The function block outputs a result of application of a predetermined process using the variables to the input data. The FB information 121 indicates a type of data to be input to the function block, a process to be applied to the data, and a type of data to be output from the function block as a result of the process. The function block may output a result of the process without using a variable.

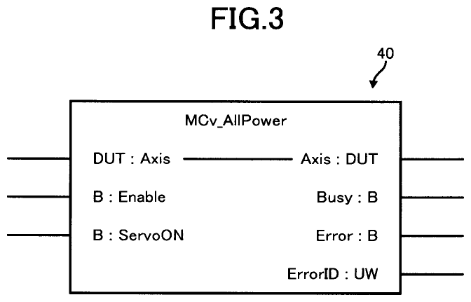

FIG. 3 illustrates an exemplary function block 40 named “MCv_AllPower”. This function block 40 is used to handle a machine 21 serving as a servo amplifier. The function block 40 receives input data, which includes data “Axis” indicating the axis to be controlled, a bit value “Enable” indicating whether to enable the function of the function block 40, and a bit value “ServoON” indicating whether to activate the servo amplifier.

The function block 40 outputs data, which includes data “Axis” equivalent to the input data “Axis”, a bit value “Busy” indicating whether the function block is under execution, a bit value “Error” indicating whether any error occurs in the function block 40, and an unsigned word “ErrorID” indicating a type of an error in the case of the error. In FIG. 3, “DUT” indicates a structure, “B” indicates a bit value, and “UW” indicates an unsigned word.

As is apparent from FIG. 3, the status of the function block 40 is represented by values of parameters related to the function block 40. These parameters include arguments as input data, and return values as output data. The parameters may include intermediate parameters used in the process for acquiring output data from input data. In some contexts of the following description, the parameters corresponding to the data input to the function block are referred to as “input arguments”, and the parameters corresponding to the data output from the function block are referred to as “output arguments”. These parameters are also collectively referred to as “arguments”.

Referring back to FIG. 1, the individual configuration information 122 is predetermined individually for the function blocks to define configurations of status images of the function blocks. The common configuration information 123 is predetermined for multiple function blocks in common to define a configuration of status images. The individual configuration information 122 and the common configuration information 123 are described in detail below.

The acquirer 11 may acquire the FB information 121, the individual configuration information 122, and the common configuration information 123 by any other procedure. For example, the acquirer 11 may download, from a server device on a network, part or all of the FB information 121, the individual configuration information 122, and the common configuration information 123 provided from the manufacturer of the machines 21. The acquirer 11 in this case of downloading the information is achieved by the communicator 36. The acquirer 11 may also read, from a non-transitory recording medium, such as a digital versatile disk (DVD) or a memory card, part or all of the FB information 121, the individual configuration information 122, and the common configuration information 123. Alternatively, the FB information 121, the individual configuration information 122, and the common configuration information 123 may be preliminarily included in the machines 21 or the program P1 on sale. The acquirer 11 corresponds to an example of acquisition means for acquiring function block information, individual configuration information, and common configuration information.

The storage 12 is mainly achieved by at least either of the main storage 32 and the auxiliary storage 33. The storage 12 stores the FB information 121, the individual configuration information 122, and the common configuration information 123, which are provided from the acquirer 11, and outputs the information in response to a request from the generator 13. The storage 12 stores multiple pieces of FB information 121 that are determined for the individual function blocks and each indicate one of mutually different function blocks. The storage 12 also stores multiple pieces of individual configuration information 122 determined individually for multiple function blocks. The storage 12 can store the FB information 121 on some function blocks for which the individual configuration information 122 is not determined and which lack the own individual configuration information 122. The storage 12 also stores a single piece of common configuration information 123 common to multiple function blocks.

The generator 13 is mainly achieved by the processor 31. The generator 13 refers to information stored in the storage 12 in response to a request from the UI 14 that receives a selection of a certain function block by the user, and thus generates a status image representing the statuses of parameters related to the function block. In detail, the generator 13 reads the FB information 121 on the selected function block from the storage 12. The generator 13 reads the individual configuration information 122 on the selected function block, when the storage 12 stores the individual configuration information 122. The generator 13 reads the common configuration information 123 instead of the individual configuration information 122, when the storage 12 does not store the individual configuration information 122. The generator 13 corresponds to an example of generation means for generating, based on the individual configuration information, the status image representing a result of the performance of the function of the function block, and outputting the generated status image to a display device.

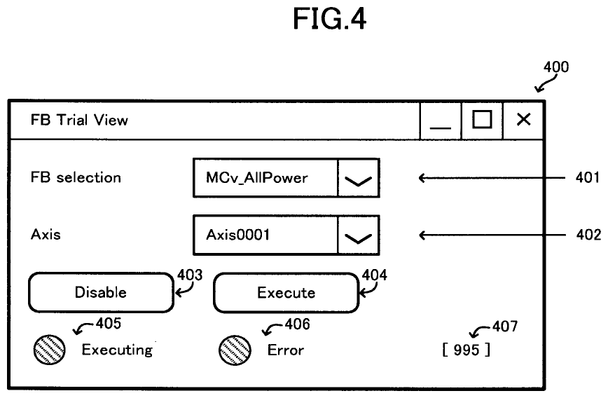

FIG. 4 illustrates a window 400 corresponding to an example of a status image generated by the generator 13. This window 400 contains a combo box 401 for selection of a function block, a combo box 402 for selection of an axis, buttons 403 and 404, and indicators 405, 406, and 407 representing the statuses of parameters. The options of the combo box 402 correspond to the data “Axis” of the function block 40 in FIG. 3, the buttons 403 and 404 respectively correspond to the input arguments “Enable” and “ServoON” of the function block 40, and the indicators 405, 406, and 407 respectively correspond to the output arguments “Busy”, “Error”, and “ErrorID” of the function block 40. The status image corresponds to an example of an image representing statuses of parameters related to each of the function blocks that result from performance of a function of the function block.

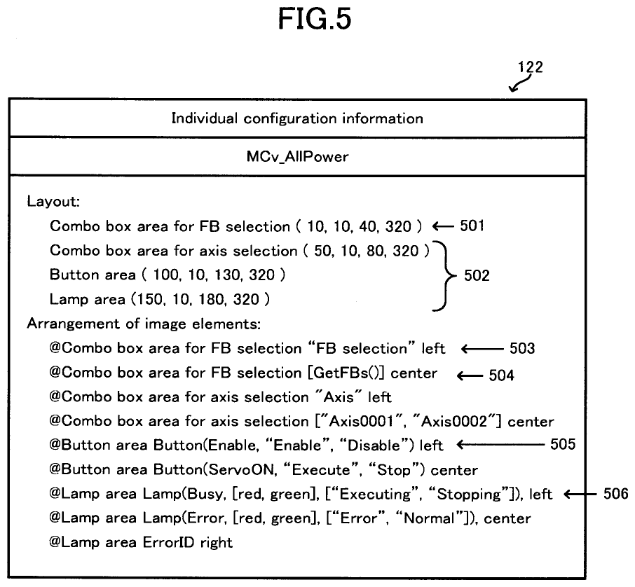

The window 400 illustrated in FIG. 4 is generated on the basis of the individual configuration information 122 illustrated in FIG. 5. This individual configuration information 122 defines the arrangement of image elements contained in the window 400. The individual configuration information 122 includes rows for defining the regions of the areas, and rows for defining the arrangement of the image elements in the areas. For example, the expression in a row 501 indicates that the area named “combo box area for FB selection” has a rectangular region defined by the position apart from the origin by 10 pixels in the vertically downward direction and 10 pixels in the horizontally rightward direction, and the position apart from the origin by 40 pixels in the vertically downward direction and 320 pixels in the horizontally rightward direction, where the origin indicates the upper left end of the window 400. The FB indicates a function block. The expressions in subsequent rows 502 define rectangular regions like that in the row 501.

The expression in a row 503 indicates that a character string “FB selection” resides in the left part of the “combo box area for FB selection”. The expression in a row 504 indicates that a combo box containing options corresponding to the elements of an array acquired as return values of a function “GetFBs ( )” resides in the central part of the “combo box area for FB selection”. The expression in a row 505 indicates that a button for receiving an input operation to “enable” or “disable” the operation, resides in the left part of the “button area” in association with the bit value “Enable” as an input argument of the function block 40. The expression in a row 506 indicates that a red or green lamp and a character string “executing” or “stopping” reside in the left part of the “lamp area”, in association with the bit value “Busy” as an output argument of the function block 40. The individual configuration information 122 thus defines the arrangement of the image elements, such as character strings, combo boxes, buttons, and lamps. At least some of the image elements to be arranged correspond to input arguments or output arguments of the function block, and appear in various manners depending on the values of the arguments. Although the manners of appearance of the image elements mean the characters constituting character strings and the colors of the image elements in this context, these are mere examples.

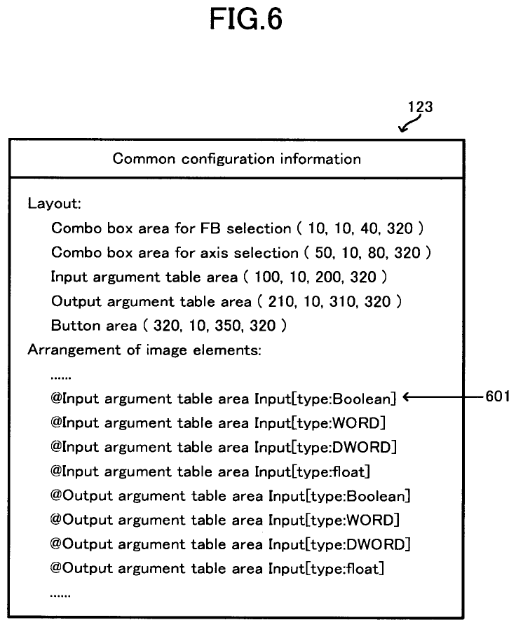

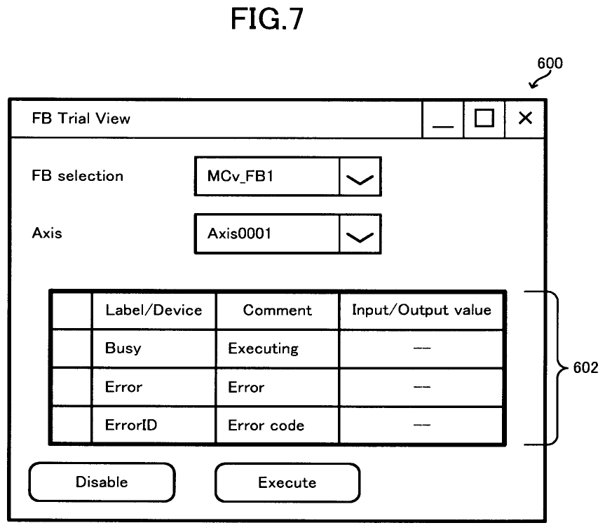

FIG. 6 illustrates an example of the common configuration information 123. This common configuration information 123 is written in the same format as the individual configuration information 122, except for that the common configuration information 123 defines the arrangement of image elements in association with various parameters contained in multiple function blocks. In other words, the common configuration information 123 contains a generalized reference expression, instead of an expression that directly refers to an argument used only in a certain function block among the function blocks associated with the common configuration information 123. For example, the expression in a row 601 in FIG. 6 indicates that all the input arguments in Boolean format are arranged within the “input argument table area”. This expression achieves generation of a window 600 like that illustrated in FIG. 7 as a status image. This window 600 contains image elements including a table 602 representing a list of input arguments of the function block.

Referring back to FIG. 1, the UI 14 is mainly achieved by cooperation of the inputter 34 and the outputter 35. The UI 14 presents a screen containing the status image generated by the generator 13 to the user, and receives an operation input by the user through this screen. For example, the UI 14 receives a selection by pressing or tapping the button 403 or 404 in FIG. 4. The UI 14 then notifies the instructor 15 of the received operation, and thus reflects this operation in the PLC 20. That is, the UI 14 serves as an input-output interface for the user, during a test run of the PLC 20 in accordance with the function block. The UI 14 corresponds to an example of a display device for displaying the status image output from the generator 13.

The instructor 15 is mainly achieved by cooperation of the processor 31 and the communicator 36. The instructor 15 causes the PLC 20 to operate in accordance with the user's operation notified from the UI 14. The user's operation in this case is intended to cause the PLC to perform the function of the function block on a trial basis. That is, the instruction from the instructor 15 to the PLC 20 can be regarded as an instruction to write an operation program equivalent to a single function block into the PLC 20 and cause the PLC 20 to execute the operation program. The input arguments of the function block are values designated by the user through the status image.

The instructor 15 then reads, from the memory of the PLC 20, the values of parameters related to the function block that result from performance of the function of the function block executed by the PLC 20, and outputs the read values to the generator 13. The generator 13, when receiving the values of parameters from the instructor 15, updates the status image using the received values and outputs the updated status image to the UI 14. This process updates the status image to be presented to the user. The instructor 15 corresponds to an example of instruction means for sending an instruction for causing the programmable controller to operate in accordance with the function block.

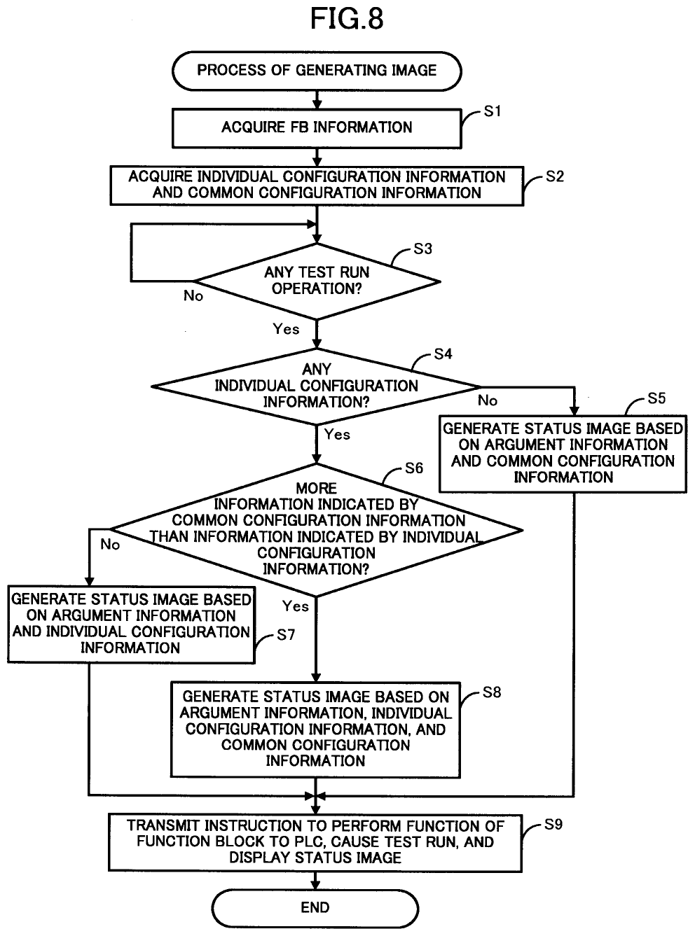

The following describes the steps of a process of generating an image executed in the image generation device 10, with reference to FIG. 8. The process of generating an image corresponds to an example of an image generation method to be executed by the image generation device. The process of generating an image does not necessarily involve the steps illustrated in FIG. 8. The details and order of the steps to be executed may be arbitrarily modified, provided that the status image representing a status of the function block is presented to the user.

In the process of generating an image, the acquirer 11 acquires FB information (Step S1), and then acquires individual configuration information and common configuration information (Step S2). In specific, the acquirer 11 reads the information from the area of a server device or a non-transitory recording medium indicated by the address designated by the user.

The generator 13 then determines whether the user inputs a test run operation for causing the PLC 20 to execute the function block (Step S3). When determining that the user does not input a test run operation (Step S3; No), the generator 13 repeats the determination in Step S3.

In contrast, when determining that the user inputs a test run operation (Step S3; Yes), the generator 13 determines whether the storage 12 stores the individual configuration information 122 associated with the function block designated in the test run operation (Step S4). When determining that the storage 12 does not stores the individual configuration information 122 (Step S4; No), the generator 13 extracts information on the arguments of the function block from the FB information 121 associated with the function block designated in the test run operation determined in Step S3, and generates a status image on the basis of the extracted information on the arguments and the common configuration information 123 (Step S5). This step yields a window 600 like that illustrated in FIG. 7.

In contrast, when determining that the storage 12 stores the individual configuration information 122 (Step S4; Yes), the generator 13 determines whether an amount of information represented by the status image based on the common configuration information 123 is larger than an amount of information represented by the status image based on the individual configuration information 122 (Step S6). In specific, the generator 13 determines whether the number of parameters referred by the expressions in the common configuration information 123 is larger than the number of parameters referred by the expressions in the individual configuration information 122, with respect to the function block designated in the test run operation determined in Step S3.

When the determination in Step S6 provides a negative result (Step S6; No), the generator 13 generates a status image, on the basis of the information on the arguments extracted from the FB information 121 as in Step S5 and the individual configuration information 122 (Step S7). This step yields a window 400 like that illustrated in FIG. 4.

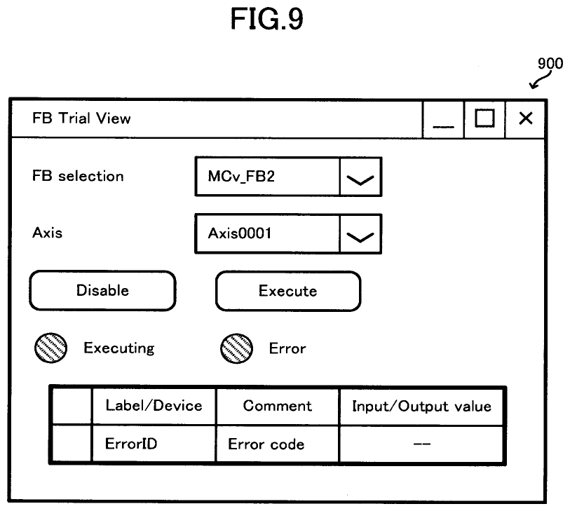

In contrast, when the determination in Step S6 provides a positive result (Step S6; Yes), the generator 13 generates a status image, on the basis of the information on the arguments extracted from the FB information 121 as in Step S5, the individual configuration information 122, and the common configuration information 123 (Step S8). In specific, the generator 13 generates a status image to be displayed, by adding a layout containing image elements related to the parameters that are referred by not the expressions in the individual configuration information 122 but the expressions in the common configuration information 123, to the status image temporarily generated on the basis of the individual configuration information 122. This step yields a window 900 illustrated in FIG. 9 as a status image of a function block named “MCv_FB2” having the output arguments identical to those of the function block 40 illustrated in FIG. 3, for example. This window 900 contains the image elements corresponding to the output arguments “Busy” and “Error” arranged on the basis of the individual configuration information 122, and the image element corresponding to the output argument “ErrorID” arranged on the basis of the common configuration information 123.

After Steps S5, S7, and S8, the image generation device 10 transmits an instruction to perform the function of the function block to the PLC 20 and thus causes a test run of the PLC 20, and presents the status image to the user (Step S9). In specific, the instructor 15 transmits an instruction, which is input by the user through the status image displayed on the UI 14, to the PLC 20 and thus operates the PLC 20, and the generator 13 reflects a result of the operation of the PLC 20 in the status image.

The process of generating an image is then terminated. The process of generating an image may be terminated at a timing when the user inputs a stop instruction, a timing when a predetermined period has elapsed, or any other timing.

As described above, the acquirer 11 acquires the individual configuration information 122 that defines the configuration of a status image, and the generator 13 generates a status image on the basis of the acquired individual configuration information 122. The maker who desires a user-friendly user interface is thus only required to prepare the individual configuration information, without designing or implementing user interfaces for the individual function blocks from scratch. The resulting user interface for observation of the functions of function blocks can therefore achieve both high user-friendliness and low burden on the user who designs and implements the user interface.

The generator 13 generates a status image on the basis of the common configuration information 123, in the case of no individual configuration information 122 associated with the function block. That is, the individual configuration information 122 does not need to be prepared for all the function blocks or distributed to users. This configuration can reduce the burden on a maker who prepares the individual configuration information 122, and eliminate the task of the user to manage a large amount of individual configuration information 122. The function block on which the individual configuration information 122 is stored in the storage 12 corresponds to an example of a first function block, and the function block on which the individual configuration information 122 is not stored in the storage 12 corresponds to an example of a second function block. The generator 13 corresponds to an example of generation means for generating, based on the individual configuration information, the status image resulting from performance of a function of the first function block, or generating, based on the common configuration information, the status image resulting from performance of a function of a second function block different from the first function block, and outputting the generated status image to the display device.

In the case where the status image on the basis of the individual configuration information 122 lacks any information, the missing information is complemented by an image element arranged on the basis of the common configuration information 123 in the generated status image. This configuration thus only requires the person to prepare the individual configuration information 122 just for especially important parameters, and can reduce the burden on the person. The parameters referred by the expressions in the individual configuration information 122 each correspond to an example of a first parameter, and the parameters referred by not the expressions in the individual configuration information 122 but the expressions in the common configuration information 123 each correspond to an example of a second parameter. The generator 13 corresponds to an example of generation means for generating, when parameters of which statuses are represented by the status image of the first function block generated based on the common configuration information contains a first parameter of which a status is represented by the status image of the first function block generated based on the individual configuration information and a second parameter different from the first parameter, the status image representing the status of the first parameter based on the individual configuration information and representing a status of the second parameter based on the common configuration information.

The individual configuration information 122 and the common configuration information 123 define the arrangement of image elements contained in a status image. This configuration can directly configure information to be presented to the user.

The test run of the PLC 20 in accordance with the function block is performed using the status image. The user in the fields can thus readily observe the operations of the PLC 20 resulting from performance of the function of the function block.

### Embodiment 2

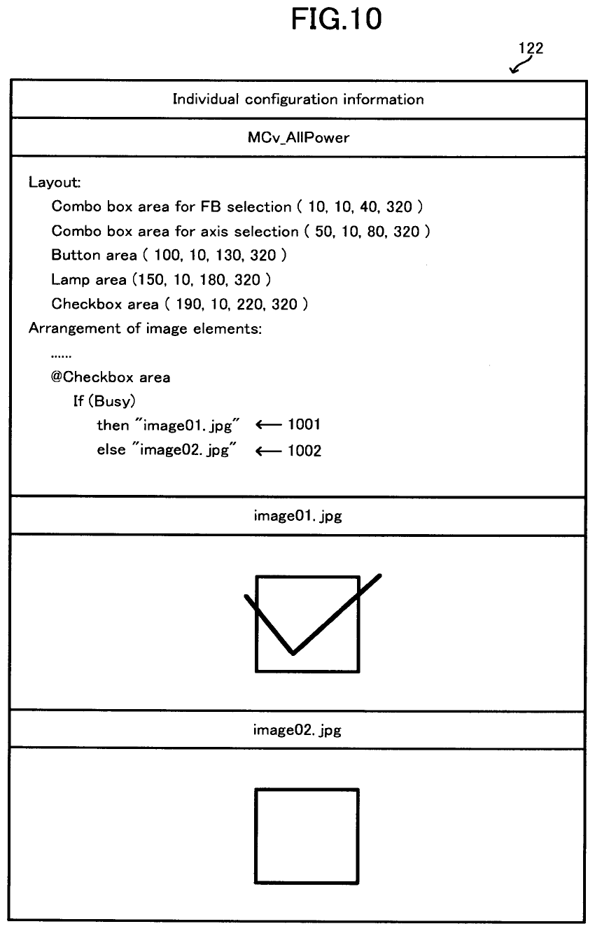

Embodiment 2 is described below focusing on the differences from Embodiment 1 described above. The components identical or corresponding to those in Embodiment 1 are provided with the same reference symbols, without redundant description or with simplified description. This embodiment differs from Embodiment 1 in that the individual configuration information 122 contains element information indicating new image elements as illustrated in FIG. 10.

The individual configuration information 122 illustrated in FIG. 10 includes rows 1001 and 1002 having expressions indicating that an image named “image01.jpg” or an image named “image02.jpg” are displayed in accordance with a value of the output argument “Busy”, and includes the image files identified by these names in the form of element information. This individual configuration information 122 produces a status image containing either of the images “image01.jpg” and “image02.jpg”.

As described above, the status image generated by the generator 13 contains new image elements because of the individual configuration information 122 containing element information indicating the new image elements. The status image can therefore be flexibly designed.

### Embodiment 3

Embodiment 3 is described below focusing on the differences from Embodiment 1 described above. The components identical or corresponding to those in Embodiment 1 are provided with the same reference symbols, without redundant description or with simplified description. This embodiment differs from Embodiment 1 in that a status image is generated on the basis of multiple pieces of common configuration information 123 having priorities.

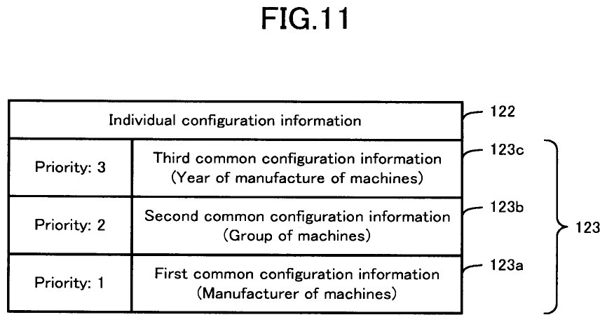

FIG. 11 illustrates the individual configuration information 122, first common configuration information 123a having a low priority of “1”, second common configuration information 123b having a middle priority of “2”, and third common configuration information 123c having a high priority of “3”, which are stored in the storage 12. The priorities indicate how much the information is prioritized. One of the pieces of common configuration information 123 having a higher priority is prioritized over another of the pieces of common configuration information 123 having a lower priority.

The generator 13 generates a status image on the basis of the individual configuration information 122. In the case where the status image generated on the basis of the individual configuration information 122 lacks any status of a parameter, the generator 13 tries to generate a status image representing the status of the missing parameter by referring to the pieces of common configuration information 123 in the descending order of priorities. In the case of no individual configuration information 122 associated with the function block of which the status is represented by the status image, the generator 13 refers to the pieces of common configuration information 123 in the descending order of priorities, and generates a status image representing the statuses of the parameters related to the function block.

Although the common configuration information 123 in this example is determined for multiple function blocks, the common configuration information 123 may also be determined for a certain group of function blocks. For example, the third common configuration information 123c may be associated with function blocks concerning machines manufactured in a certain year, the second common configuration information 123b may be associated with function blocks concerning a group of machines having a model number represented by a character string beginning with “AB”, and the first common configuration information 123a may be associated with function blocks concerning machines produced by a certain manufacturer.

As described above, a status image is generated by using multiple pieces of common configuration information having priorities in the order of priorities. The configuration of the status image can therefore be more flexibly designed.

The priorities do not need to be explicitly defined. For example, the priorities may also be determined by the inheritance of common configuration information 123 by another common configuration information 123, like the inheritance of classis in programming languages.

The above-described embodiments are not to be construed as limiting the scope of the present disclosure.

For example, the individual configuration information 122 and the common configuration information 123 may be written in any procedure. For example, the information may be written in extensible markup language (XML).

Although the PLC 20 executes an operation program equivalent to a single function block in the above description, this configuration is a mere example. The instructor 15 may cause the PLC 20 to execute an operation program containing a function block of which the status is represented by the status image and containing other source codes, in accordance with an instruction from the user.

The common configuration information 123 may define the arrangement of image elements corresponding to the parameters in all the types of data formats applicable to operation programs, in order to achieve generation of a status image of any function block.

Although the image generation device 10 includes the UI 14 serving as a display device for displaying a status image in the above description, the image generation device 10 may output a status image to an external display device.

Although the image generation device 10 generates a status image representing a result of a test run of the PLC 20 based on the function of the function block, this configuration is a mere example. For example, the image generation device 10 may generate a status image resulting from a simulation of the function of the function block without an actual operation of the PLC 20.

The functions of the image generation device 10 may be achieved by dedicated hardware or an ordinary computer system.

For example, the program P1 to be executed by the processor 31 may be stored into a non-transitory computer-readable recording medium and distributed. The program P1 when being installed in a computer can configure a device for executing the above-described processes. Examples of such a non-transitory recording medium include flexile disk, compact disc read-only memory (CD-ROM), DVD, and magneto-optical disc (MO).

The program P1 may also be stored in a disk device included in a server device on a communication network, such as the Internet, and may be downloaded into a computer by being superimposed on a carrier wave, for example.

Alternatively, the program P1 may be activated while being transferred through a communication network, to execute the above-described processes.

A server device may execute all or part of the program P1, and a computer may execute the program while transmitting and receiving information on the executed processes to and from the server device via a communication network, to execute the above-described processes.

In the case where the above-described functions are shared by an operating system (OS) or achieved by cooperation of the OS and applications, only the components other than the OS may be stored into a non-transitory medium and distributed, or downloaded into a computer.

The functions of the image generation device 10 may also be performed by means other than software. Part or all of the functions may be performed by dedicated hardware including circuits.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is suitable for development of operation programs to be executed by programmable controllers.

### REFERENCE SIGNS LIST

100 Programmable controller system
10 Image generation device
11 Acquirer
12 Storage
121 FB information
122 Individual configuration information
123 Common configuration information
123a First common configuration information
123b Second common configuration information
123c Third common configuration information
13 Generator
14 UI
15 Instructor
20 PLC
21 Machine
31 Processor
32 Main storage
33 Auxiliary storage
34 Inputter
35 Outputter
36 Communicator
37 Internal bus
50 Function block
400, 600, 900 Window
401, 402 Combo box
403, 404 Button
405 to 407 Indicator
501 to 506, 601 Row
602 Table
P1 Program

1. A non-transitory computer-readable recording medium storing an image generation program, the image generation program causing a computer to execute processing comprising:
acquiring function block information indicating a function block corresponding to a routine contained in an operation program for operating a programmable controller;
acquiring individual configuration information determined individually for the function block, the individual configuration information being input by a user and defining a configuration of a status image representing statuses of parameters related to the function block, the statuses resulting from performance of a function of the function block; and
generating, based on the individual configuration information, a window containing the status image representing a result of the performance of the function of the function block, and outputting the generated window to a display device.

2. A non-transitory computer-readable recording medium storing an image generation program, the image generation program causing a computer to execute processing comprising:
acquiring function block information indicating a function block corresponding to a routine contained in an operation program for operating a programmable controller;
acquiring individual configuration information determined individually for the function block, the individual configuration information defining a configuration of a status image representing statuses of parameters related to the function block, the statuses resulting from performance of a function of the function block; and
generating, based on the individual configuration information, the status image representing a result of the performance of the function of the function block, and outputting the generated status image to a display device, wherein
the acquiring of the individual configuration information includes acquiring pieces of function block information indicating mutually different function blocks, individual configuration information determined for a first function block among the function blocks, and common configuration information common to the function blocks and defining a configuration of the status image, and
the means generating and outputting includes
generating, based on the individual configuration information, the status image resulting from performance of a function of the first function block, and generating, based on the common configuration information, the status image resulting from performance of a function of a second function block different from the first function block, and
outputting the generated status image to the display device.

3. The non-transitory computer-readable recording medium according to claim 2, wherein when parameters of which statuses are represented by the status image of the first function block generated based on the common configuration information contain a first parameter of which a status is represented by the status image of the first function block generated based on the individual configuration information and a second parameter different from the first parameter, the generating of, based on the individual configuration information, the status image includes generating the status image representing the status of the first parameter based on the individual configuration information and representing a status of the second parameter based on the common configuration information.

4. The non-transitory computer-readable recording medium according to claim 2, wherein
the acquiring of the common configuration information includes acquiring pieces of the common configuration information having priorities, and
the generating and outputting includes generating the status image, such that the individual configuration information is prioritized over the pieces of common configuration information, and one of the pieces of common configuration information having a higher priority is prioritized over another of the pieces of common configuration information having a lower priority.

5. The non-transitory computer-readable recording medium according to claim 1, wherein
the individual configuration information defines arrangement of image elements contained in the status image, and
the image elements include an image element corresponding to any of the parameters.

6. The non-transitory computer-readable recording medium according to claim 5, wherein
the individual configuration information contains element information indicating the image element, and
the generating and outputting includes generating, based on the individual configuration information, the status image containing the image element indicated by the element information.

7. The non-transitory computer-readable recording medium according to a claim 1, storing the image generation program further causing the computer to execute processing comprising:
sending an instruction for causing the programmable controller to operate in accordance with the function block, wherein
the generating and outputting includes generating the status image representing a result of an operation of the programmable controller in accordance with the instruction.

8. An image generation device comprising:
processing circuitry
acquire function block information indicating a function block corresponding to a routine contained in an operation program for operating a programmable controller,
acquire individual configuration information determined individually for the function block, the individual configuration information being input by a user and defining a configuration of a status image representing statuses of parameters related to the function block, the statuses resulting from performance of a function of the function block, and
generate, based on the individual configuration information, a window containing the status image representing a result of the performance of the function of the function block, and output the generated window to a display device.

9. A programmable controller system comprising:
the image generation device according to claim 8; and
the programmable controller, wherein
the processing circuitry further
sends an instruction for causing the programmable controller to operate in accordance with the function block, and
generates the status image representing a result of an operation of the programmable controller in accordance with the instruction.

10. (canceled)

11. An image generation device comprising:
processing circuitry to
acquire function block information indicating a function block corresponding to a routine contained in an operation program for operating a programmable controller,
acquire individual configuration information determined individually for the function block, the individual configuration information defining a configuration of a status image representing statuses of parameters related to the function block, the statuses resulting from performance of a function of the function block, and
generate, based on the individual configuration information, the status image representing a result of the performance of the function of the function block, and output the generated status image to a display device, wherein
the processing circuitry
acquires pieces of function block information indicating mutually different function blocks, individual configuration information determined for a first function block among the function blocks, and common configuration information common to the function blocks and defining a configuration of the status image,
generates, based on the individual configuration information, the status image resulting from performance of a function of the first function block, and generates, based on the common configuration information, the status image resulting from performance of a function of a second function block different from the first function block, and
outputs the generated status image to the display device.

12. A programmable controller system comprising:
the image generation device according to claim 11; and
the programmable controller, wherein
the processing circuitry
sends an instruction for causing the programmable controller to operate in accordance with the function block, and
generates the status image representing a result of an operation of the programmable controller in accordance with the instruction.

13. The non-transitory computer-readable recording medium according to claim 2, wherein
the individual configuration information defines arrangement of image elements contained in the status image, and
the image elements include an image element corresponding to any of the parameters.

14. The non-transitory computer-readable recording medium according to claim 13, wherein
the individual configuration information contains element information indicating the image element, and
the generating of, based on the individual configuration information, the status image includes generating, based on the individual configuration information, the status image containing the image element indicated by the element information.

15. The non-transitory computer-readable recording medium according to claim 2, storing the image generation program further causing the computer to execute processing comprising:
sending an instruction for causing the programmable controller to operate in accordance with the function block, wherein
the generating and outputting includes generating the status image representing a result of an operation of the programmable controller in accordance with the instruction.
